(19) United States
(12) Patent Application Publication
(10) Pub. No.: US 2002/0077082 A1
(43) Pub. Date: Jun. 20, 2002

(54) Voice message presentation on personal wireless devices

(75) Inventor: Brian Cruickshank, Oakville (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/737,592

(22) Filed: Dec. 18, 2000

(51) Int. Cl. H04M 11/10

(52) U.S. Cl. 455/413; 455/412; 455/556

(57) ABSTRACT

Voice messages are downloaded from a voice messaging server to a handheld computing device where the voice messages may be reviewed and acted upon. The voice messages may first be converted from the file format native to the voice messaging server into a compressed data format. The result of the compression, a message file, may include a compressed audio portion and an information portion, which includes details associated with the message such as calling line ID and time of day. In one scheme, the compression is performed at the voice messaging server and the message files are downloaded to the handheld over a wireless connection. In another scheme, compression may be performed at a desktop PC which has downloaded voice messages from the voice messaging server. A connection between the handheld and the desktop PC allows a transfer of the message files to the handheld computing device. Once the message files are stored on the handheld computing device, a voice message interface application executed by the handheld computing device allows text details associated with the voice message to be displayed. The audio portion of the message files may be reviewed using audio playback capabilities that are standard on many handheld computing devices.

### FIELD OF THE INVENTION

The present invention relates to voice messaging and, in particular to voice message presentation on personal wireless devices.

### BACKGROUND OF THE INVENTION

When telephone voice messaging was introduced, analog audio signals were recorded to magnetic media, such as magnetic tape. As various aspects of voice communication became digital, storage of voice messages also became digital. Storage of voice messages as digital audio also allowed an association of voice message details with each stored voice message. These details may include an indication of the identity of calling line, the time of day the voice message was received by the voice messaging system and an indication of the urgency of the voice message.

Typically, voice messages are reviewed through the use of a telephone. A user may call a voice message system, authenticate himself and review messages using the standard interface presented by a telephone. Dual Tone Multi-Frequency (DTMF) sounds may be generated using the telephone keypad to enter a password or indicate an action (listen, save, delete) to perform on a particular voice message. Often message details may only be reviewed by requesting the details, for instance, by pressing the “5” key on the telephone keypad while listening to a voice message.

Desktop personal computer-based voice messaging systems are familiar. Such systems allow a user to review the details associated with a particular voice message before performing an action (open for listening, save, delete) on that voice message. For instance, the user may review the indication of the identity of the calling line and deduce the identity of the person associated with the voice message (the caller).

While away from a desktop telephone or personal computer, a user of a voice messaging system may typically review voice messages though the use of any telephone. However, use of a telephone to review voice messages may incur charges, for instance, long distance charges, pay telephone tolls or cellular airtime charges.

### SUMMARY OF THE INVENTION

A model is proposed wherein voice messages may be downloaded from a voice messaging server to a handheld computing device. The voice messages may first be converted from the file format native to the voice messaging server into a compressed data format. The result of the compression, a message file, may include a compressed audio portion and an information portion, which includes details associated with the voice message such as calling line ID and time of day. In one scheme, the compression is performed at the voice messaging server and the message files are downloaded to the handheld over a wireless connection. In another scheme, compression may be performed at a desktop PC which has downloaded voice messages from the voice messaging server. A connection between the handheld and the desktop PC allows a transfer of the message files to the handheld computing device. Once the message files are stored on the handheld computing device, a voice message interface application executed by the handheld computing device allows text details associated with the voice message to be displayed. The audio portion of the message files may be reviewed using audio playback capabilities that are standard on many handheld computing devices.

In accordance with an aspect of the present invention there is provided a method of providing voice messaging services at a handheld computing device including communicating with a voice messaging repository to receive a voice message, locally storing the received voice message and locally providing an interface to the user allowing the user to indicate an action to perform on the received voice message. In another aspect of the present invention, a handheld computing device is provided for carrying out this method. In a further aspect of the present invention, there is provided a software medium that permits a handheld computing device to carry out this method.

In accordance with another aspect of the present invention there is provided a method of creating a voice message at a handheld computing device including recording the voice message using audio recording capabilities of the handheld computing device, receiving, through a local interface, an indication of an intended recipient of the voice message and communicating with a voice messaging repository to transfer the voice message in association with information identifying the intended recipient.

In accordance with a further aspect of the present invention there is provided a method of providing voice messaging services at a handheld computing device including communicating with a voice messaging repository to receive, at the handheld computing device, information regarding a voice message, locally storing the received information, and locally providing an interface to the user, where the interface allows the user to review the information and indicate an action to perform on the voice message. The method further includes transmitting, to the voice messaging repository, instructions to perform the action on the voice message.

Other aspects and features of the present invention will become apparent to those of ordinary skill in the art upon review of the following description of specific embodiments of the invention in conjunction with the accompanying figures.

### BRIEF DESCRIPTION OF THE DRAWING

In the figure that illustrates example embodiments of this invention:

FIG. 1 schematically illustrates a communication system suitable for use with embodiments of the present invention.

### DETAILED DESCRIPTION

With increasing use of electronic mail (e-mail) the general public is becoming familiar with an alternative messaging interface to the typical voice mail interface that may be called a text messaging interface. A user of a text messaging interface based on a desktop personal computer (PC) may review details associated with a number of text messages before performing an action (open for reading, save, delete) on a particular text message. In one model, the text messages are downloaded to, and stored on, the desktop PC. However, in another model, the text messages are stored on a central server. A particular text message may be (temporarily) downloaded when the user of the central server chooses to open the text message for reading. Advantageously, the central server model allows the user to review text messages from locations other than the desktop PC. For instance, a user may connect to a central text messaging server using a handheld wireless device and review text messages on the handheld wireless device. Such a handheld wireless device is marketed by Research in Motion of Waterloo, Canada under the name Blackberry™.

In an alternative scheme, rather than using a direct connection to a text message server, text messages may be downloaded from desktop PC to handheld when a session takes place that synchronizes content on the desktop PC with content on the handheld. The user may then review the text messages while away from the desktop PC. Further, a user of this latter system may review text messages when in a location where a wireless connection to a server may be difficult, say, on a subway train. The present invention adapts handhelds to handle voice messages, which are significantly larger files than text messages.

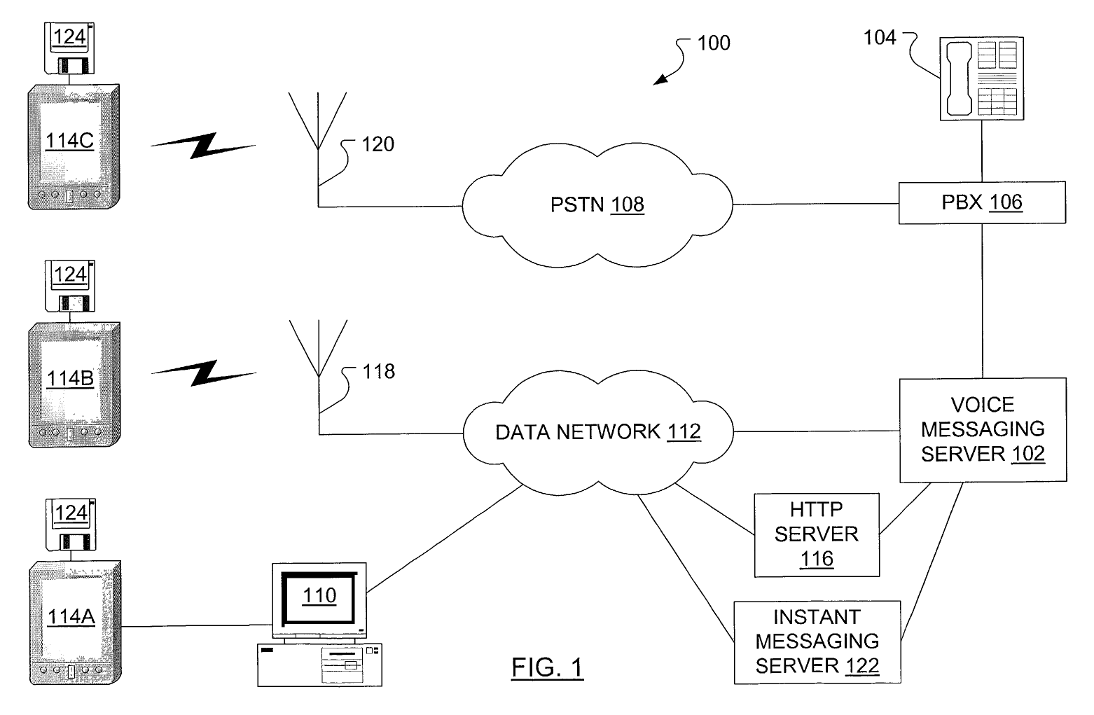

FIG. 1 illustrates a communication system 100 including a voice messaging server 102 to which a telephone station apparatus 104 connects via a private branch exchange 106. The telephone station apparatus 104 may also connect to a public switched telephone network (PSTN) 108 via the private branch exchange 106. A desktop personal computer (PC) 110 may connect to the voice messaging server 102 via a data network 112. A handheld computing device 114A (generically the handheld 114) connects to the desktop PC 110 for synchronizing content, which may include voice messages received over the data network 112 at the desktop PC 110. Another handheld 114B connects to the voice messaging server 102 via a wireless connection to a data tower 118 that connects to the data network 112. An HTTP (Hyper-Text Transport Protocol) server 116 may be associated with the voice messaging server 102 to assist the handheld 114B in accessing the voice messaging server 102 via the data network 112. An instant messaging server 122 may be associated with the voice messaging server 102 to alert the handheld 114B to new messages present at the voice messaging server 102. Still another handheld 114C connects to the voice messaging server 102 via the PSTN 108 by first establishing a cellular telephony connection with a cellular tower 120. Each handheld 114A, 114B, 114C may be loaded with routing system software for executing methods exemplary of this invention via a connection to the PC 110, as is conventional, or from a software medium 124 which could be a disk, a tape, a chip or a random access memory containing a file downloaded from a remote source.

In overview, voice messages may be downloaded from the voice messaging server 102 to the handheld 114. To conserve memory or reduce download time, the voice messages may first be converted from the file format native to the voice messaging server 102 into a compressed data format. The result of the compression, a message file, may include a compressed audio portion and an information portion, which includes details associated with the message such as calling line ID and time of day. Once the message files are stored on the handheld 114, a voice message interface application executed by the handheld 114 allows text details associated with each voice message to be displayed. The audio portion of the message files may be reviewed using audio playback capabilities that are standard on many handheld computing devices.

In a first scheme, voice messages may be downloaded from the voice messaging server 102 onto the desktop PC 110 where the conversion may be performed from the file format native to the voice messaging server 102 into a compressed audio format. A message file resulting from the conversion is stored on the desktop PC 110 corresponding to each voice message. A connection between the handheld 114A and the desktop PC 110 allows a transfer of the message files to the handheld 114A. As is known, the connection between the desktop PC 110 and the handheld 114A may be through a “hot sync” cradle attached via a Universal Serial Bus (USB) connection or other serial cable. Alternatively, the handheld 114A may synchronize with the desktop PC 110 over a wireline Local Area Network (LAN), a wireless LAN or an infra-red connection. In this scheme, the desktop PC 110 may be considered to act as a “voice messaging repository” while in other schemes, the voice messaging server 102 may be considered to act as the voice messaging repository.

One suitable compressed audio format is a standard proposed by the Moving Picture Experts Group (MPEG), which develops standards for digital video and digital audio compression, called MPEG-1 Audio Layer-3 (MP3). MP3 is a standard technology and format for compressing a sound sequence into a very small file while preserving a level of sound quality when the sound sequence is played. Conversion of voice message files from the file format native to the voice messaging server 102 into MP3 format can be done, for instance, at the voice messaging server 102, at the desktop PC 110 or even at the handheld 114.

While storing an MP3 format version of a voice message, additional ‘envelope’ information may be stored. Additional information that is typically stored associated with a voice message includes calling line ID, the time of day the voice message was received and an indication of the urgency of the voice message. This additional information may be stored in text fields that are provided for in the aforementioned standard that defines MP3 file compression.

Additionally, business card information about the caller can also be stored in association with the compressed voice message. For instance, a “vCard.” A vCard is an electronic business card and is also the name of a specification for the kind of communication exchange that may be performed with such business cards. vCards can include images and sound as well as text. If a vCard is received in association with a message file, the voice message interface application may associate the vCard and the message file based on file naming conventions. Whether or not a user decides to listen to the message file, the voice message interface application may allow the user to save the information included in the vCard to an address book application.

Just as in the cases of a voice message review using a telephone-based interface or a PC-based interface, voice message review using a voice message interface application based on the handheld 114A may include indicating various actions (listen, save, delete) to perform on a particular voice message. After a voice message review, the handheld 114A may be connected to the desktop PC to re-synchronize, at which point the actions performed on the voice messages at the handheld 114A (delete, file in a specific folder) may be performed on the voice messages at the desktop PC 110 and at the voice messaging server 102. Further, any changes in status (unplayed, played, deleted, sent, unsent) of the voice messages at the handheld 114A may also be communicated to the desktop PC 110 and to the voice messaging server 102, through the synchronization process. Synchronization with the voice message server 102 may also be done ‘online’ via a low bit-rate wireless data link.

The handheld 114 may be chosen from among many appropriate models such as those each known as a “PocketPC” and marketed by such companies as Casio Computer Co., Ltd. Of Tokyo, Japan, Compaq Computer Corporation of Houston, Texas and Hewlett-Packard of Palo Alto, Calif. The handheld 114 may also be one of many models of Palm devices marketed by Palm Inc. of Santa Clara, Calif.

In one embodiment of the present invention, the voice message interface application presented on the handheld 114 is written in the Java™ programming language to ensure portability and independence from the computing architecture of the handheld 114. Ideally then, included in the software on the handheld 114 is a Micro Java virtual machine.

In a second scheme, voice messages may be downloaded from the voice messaging server 102 onto the handheld 114B directly (i.e., without storage at the desktop PC 110) via a wireless connection from the handheld 114B to the data network 112 facilitated by the data tower 118. Conversion from the file format native to the voice messaging server 102 into a compressed audio format, in this second scheme, may be performed at the voice messaging server 102.

In one embodiment of this second scheme, the user may instruct the voice message interface application to establish a TCP/IP (Transport Control Protocol/Internet Protocol) connection with the voice messaging server 102 over the data network 112. The message files could then be downloaded to the handheld 114B over this TCP/IP connection and reviewed by the user. Some handheld computing devices exemplary of the handheld 114B already include wireless connectivity features for TCP/IP data communication.

Some actions that may be performed on a specific message file after download, for instance, reply to the message file, delete the message file or forward the message file, may require further contact with the voice messaging server 102. The necessary instructions to perform these actions may be sent using HTTP encoded command strings. The command strings may be interpreted by a common gateway interface (CGI) script running on the HTTP server 116. The CGI script is a standard way for an HTTP server to pass data, received as HTTP encoded data, to an application program (such as would be executed by the voice messaging server 102) and to receive data back for forwarding to the source of the data. Advantageously, when HTTP encoded data is used to communicate with the voice messaging server 102 over the wireless TCP/IP connection, the data is “firewall friendly”. That is to say, HTTP encoding allows the handheld 114B to communicate with the voice messaging server 102 even if a firewall is placed between the data network 112 and the voice messaging server 102. Alternatively, the voice messaging server 102 may provide an Internet Message Access Protocol (IMAP) or Simple Mail Transfer Protocol (SMTP) interface over TCP/IP which allows the remote user to perform the same functions.

At times, the handheld 114B may be connected to the data network 112 for activities other than receiving voice messages. These activities may include downloading e-mail messages or browsing the World Wide Web. It may be that, while connected to the data network 112 for these activities, the user of the handheld 114B is also in communication with an instant messaging service provided by the instant messaging server 122. Clients for such services are presently known and include AOL Instant Messenger^{SM}, MSN® Messenger and Yahoo!® Messenger.

If the handheld 114B is in communication with the instant messaging server 122, it may be assumed that an instant messaging client for the service provided by the instant messaging server 122 is being executed by the handheld 114B. A user of the handheld 114B may, while reviewing a particular voice message, wish to initiate an instant messaging session with the caller associated with the particular voice message. The voice message interface application receives an indication, from the user, of a desire to connect with the caller using instant messaging. The voice message interface application may communicate information from a “From” field associated with the particular voice message to the instant messaging client. The instant messaging client may then attempt to initiate an instant messaging session with the caller.

If the voice messaging server 102 is aware that the handheld 114B is in communication with the instant messaging server 122, the voice messaging server 102 may have occasion to act as an instant messaging client. Upon the arrival of a new voice message for the user of the handheld 114B, the voice messaging server 102 may send an indication to the user of the handheld 114B that a new voice message has arrived. This indication may be sent through communication via the instant messaging server 122. The indication may be simply “You have 1 new voice message.” However, additional detail associated with the voice message may also be sent to enhance the indication. For instance, “You have a new voice message from Bob Smith at ABC 123 Inc.” Further enhancements to the indication may include a speech-to-text transcription of the voice message or, given enough bandwidth on the connection between the handheld 114B and the data network 112, the message file.

In a further embodiment of the present invention, the handheld 114B is equipped with a voice recorder, and a user may record and send voice messages to the voice messaging server 102 over the established TCP/IP link. In the first scheme however, a recorded voice message would be stored on the handheld 114A until the next time a synchronization operation is performed with the desktop PC 110.

In a still further embodiment of the present invention, the handheld 114C is equipped with a cellular telephone. The voice messaging application, executed on the handheld 114C so equipped, may connect to the voice messaging server 102 over the PSTN 108 after first establishing a connection with the cellular tower 120. Once a voice connection has been established, the voice messaging application may receive voice messages from the voice messaging server 102. This receipt of voice messages from the voice messaging server 102 may involve the playback of the voice message over the voice connection as is known, or may involve a data connection established in parallel to the voice connection. This data connection may be used to download voice messages for storage on the handheld 114C. Although downloading the voice messages allows playback when no longer connected to a network, playing back the voice messages over the voice connection uses less of the resources of the handheld 114C. A combination of the two is also advantageous in the event that a voice message has a non-voice attachment (e.g., a text or binary file or a fax).

Alternatively, the voice messaging application on the handheld 114C may receive a list of messages and identify to the voice messaging server 102 a particular voice message (e.g., by entering a Universal ID for the particular voice message) that the user wishes to access. This reception of a list and identification of a particular voice message may use the voice connection (say through a DTMF key sequence) or may use the parallel data connection described above. Subsequent to identifying the particular voice message, the voice messaging application on the handheld 114C may request that a specific action (e.g., forward the voice message to a certain user) be performed on the identified voice message. Where dialing information is stored on the handheld 114C associated with the certain user, the dialing information may be used to automatically address the voice message. Again, the interaction with the voice messaging server 102 may use the voice connection or a parallel data connection. For instance, the voice messaging application may present an interface with a “To:” line on which the certain user may be indicated by using input capabilities of the handheld 114C (e.g., mini-keyboard or touch screen) to browse an address book stored on the handheld 114C and select the certain user. Calls may also be addressed using the caller ID information associated with the voice message (e.g., extracted from the MP3 file) so that the user can easily perform a ‘Call Sender’ action. Also, the software can provide a ‘reply/reply all’ capability for e-mails so that the user can reply via either via a voice message or an e-mail. Otherwise, the user may address the identified voice message by the name of the certain user and the voice messaging server 102 can look up the dialing information in an address book stored on the voice messaging server 102.

The user may also wish to forward a voice message without downloading it, based on the ‘envelope’ information. For example, after downloading information about all of the new messages that have arrived since the handheld 114C was last synchronized, the user may decide that a particular message needs immediate attention by a co-worker and instruct the voice messaging server to forward the message to that person without downloading it first. This reduces the time, cost and resources (of the handheld 114C) required to handle new messages.

Notably, in upcoming third generation (3G) wireless devices, the voice connection and data connection will both be carried over the same TCP/IP data connection.

As will be apparent to a person skilled in the art, the conversion of the voice messages to compressed message files may not always be necessary. The conversion is suggested herein due, in part, to memory constraints of current handheld computing devices. Even where the handheld 114 is without memory constraints, compression may be preferred to minimize time allocated to the transfer of message files to the handheld 114. The conversion may be performed at the voice messaging server 102 or the handheld 114. Furthermore, typical voice messaging servers use proprietary digital audio formats to store voice messages and thus, to take advantage of existing, standard playback capabilities of handheld computing devices, MP3 is a preferred format. As is known, however, many digital formats exist for handling audio, whether compressed or not, including Adaptive Differential Pulse Code Modulation (ADPCM) format and RealAudio™ format.

Advantageously, the voice messaging interface application allows a user to browse through messages “off line” by providing textual and graphical information about the voice message to the user via a display capability of the handheld 114. Further, the location of the user relative to communication capabilities, i.e., distant from the desktop PC 110 or out of range of a wireless connection, may not influence the ability of the user to review voice messages.

Other modifications will be apparent to those skilled in the art and, therefore, the invention is defined in the claims.

We claim:

1. A method of providing voice messaging services at a handheld computing device comprising:
communicating with a voice messaging repository to receive a voice message at said handheld computing device;
locally storing said received voice message; and
locally providing an interface to said user allowing said user to indicate an action to perform on said received voice message.

2. The method of claim 1 further comprising:
receiving an indication of said action to perform on said received voice message; and
responsive to receiving said indication, performing said action.

3. The method of claim 2 wherein said action is “play” and said performing said action further comprises:
generating an audio signal from said received voice message; and
outputting said audio signal to an audio output device associated with said handheld computing device.

4. The method of claim 2 wherein said action is “delete” and said performing said action further comprises further communicating with said voice messaging repository to indicate a deletion of said received voice message.

5. The method of claim 2 wherein said action is “forward” and said performing said action further comprises:
receiving an indication of an intended recipient of said received voice message; and
further communicating with said voice messaging repository to transfer information identifying said intended recipient.

6. The method of claim 5 wherein said information identifying said intended recipient is a telephone number.

7. The method of claim 6 wherein said indication is a name and said method further includes locally mapping said name to said telephone number.

8. The method of claim 1 further comprising:
extracting, from said received voice message, information related to said received voice message; and
using said interface to present said information related to said received voice message.

9. The method of claim 8 wherein said interface comprises a display for display of said information related to said received voice message.

10. The method of claim 1 wherein said voice messaging repository is a desktop personal computer and said communicating with said voice messaging repository occurs over a wired connection.

11. The method of claim 1 wherein said voice messaging repository is a voice messaging server and wherein said communicating with said voice messaging server occurs over a data network.

12. The method of claim 11 further comprising establishing a connection to said data network.

13. The method of claim 12 further comprising employing the Internet Protocol for said communicating with said voice messaging server.

14. The method of claim 13 further comprising employing the Hyper-Text Transfer protocol for said communicating with said voice messaging server.

15. The method of claim 1 wherein said voice messaging repository is a voice messaging server and wherein said communicating with said voice messaging server occurs over a public switched telephone network.

16. The method of claim 15 further comprising establishing a connection to said public switched telephone network.

17. The method of claim 16 further comprising generating Dual Tone Multi-Frequency tones for said communicating with said voice messaging server.

18. The method of claim 1 further comprising compressing said received voice message to reduce memory required for voice message storage.

19. The method of claim 1 further comprising, before said communicating with said voice messaging repository to receive said voice message, receiving an indication of arrival of a voice message from said voice messaging repository.

20. The method of claim 19 wherein said indication of arrival includes details associated with said received voice message.

21. The method of claim 1 wherein said communicating with said voice messaging repository further comprises indicating to said voice messaging repository a status of voice messages previously received at said handheld computing device.

22. The method of claim 21 wherein, for each of said previously received voice messages, said status is one of unplayed, played, deleted, sent and unsent.

23. A handheld computing device comprising:
means for communicating with a voice messaging repository to receive a voice message;
means for locally storing said received voice message; and
means for locally providing an interface to said user allowing said user to indicate an action to perform on said received voice message.

24. A computer readable medium containing computer-executable instructions which, when performed by a processor in a handheld computing device, cause the processor to:
communicate with a voice messaging repository to receive a voice message;
locally store said received voice message; and
locally provide an interface to said user allowing said user to indicate an action to perform on said received voice message.

25. A method of creating a voice message at a handheld computing device comprising:
recording said voice message using audio recording capabilities of said handheld computing device;
receiving, through a local interface, an indication of an intended recipient of said voice message; and
communicating with a voice messaging repository to transfer said voice message in association with information identifying said intended recipient.

26. A method of providing voice messaging services at a handheld computing device comprising:
communicating with a voice messaging repository to receive, at said handheld computing device, information regarding a voice message;
locally storing said received information;
locally providing an interface to said user, where said interface allows said user to review said information and indicate an action to perform on said voice message; and
transmitting, to said voice messaging repository, instructions to perform said action on said voice message.
